(19) United States
(12) Patent Application Publication
(10) Pub. No.: US 2025/0217990 A1
(43) Pub. Date: Jul. 3, 2025

(54) SELF-ATTENTION IN FREQUENCY DOMAIN FOR IMAGE SEGMENTATION

(71) Applicant: International Business Machines Corporation, Armonk, NY (US)

(72) Inventors: Chun Lok Wong, San Jose, CA (US); HONGZHI WANG, Santa Bruno, CA (US); Tanveer F. Syeda-Mahmood, Cupertino, CA (US)

(21) Appl. No.: 18/402,785

(22) Filed: Jan. 3, 2024

(51) Int. Cl. G06T 7/11

(52) U.S. Cl. CPC G06T 7/11; G06T 2207/20021; G06T 2207/20048; G06T 2207/20081; G06T 2207/20084

(57) ABSTRACT

Embodiments of the present invention provide computer-implemented methods, computer program product, and computer systems. One or more processors access an image file. The one or more processors input the image file into a deep learning model, where the deep learning model includes multiple blocks, each block of the multiple blocks including a Hartley transform, mixings of features in the frequency domain with a set of learnable parameters to produce new features, and an inverse of the Hartley transform. The one or more processors output another image file containing segmentation results of the accessed image file.

### STATEMENT REGARDING PRIOR DISCLOSURES BY THE INVENTOR OR A JOINT INVENTOR

The following disclosure(s) are submitted under 35 U.S.C. § 102 (b) (1) (A):

### DISCLOSURE(S)

(1) Chun Lok Wong, Hongzhi Wang, and Tanveer F. Syeda-Mahmood, “HartleyMHA: Self-attention in Frequency Domain for Resolution-Robust and Parameter-Efficient 3D Image Segmentation”, Lecture Notes in Computer Science book series (LNCS, volume 14223), Oct. 1, 2023, https://link.springer.com/chapter/10.1007/978-3-031-43901-8_35.

### BACKGROUND

The present invention relates generally to image segmentation, and more particularly to attention-based transformers.

Neural networks (NNs) are computing systems inspired by biological neural networks. NNs are not simply algorithms, but rather a framework for many different machine learning algorithms to work together and process complex data inputs. Such systems “learn” to perform tasks by considering examples, generally without being programmed with any task-specific rules. For example, in image recognition, NNs learn to identify images that contain cats by analyzing example images that are correctly labeled as “cat” or “not cat” and using the results to identify cats in other images. NNs accomplish this without any prior knowledge about cats, for example, that cats have fur, tails, whiskers, and pointy ears. Instead, NNs automatically generate identifying characteristics from the learning material. NNs are based on a collection of connected units or nodes called artificial neurons, which loosely model the neurons in a biological brain. Each connection, like the synapses in a biological brain, can transmit a signal from one artificial neuron to another. An artificial neuron that receives a signal can process the signal and then transfer the signal to additional artificial neurons.

In common NN implementations, the signal at a connection between artificial neurons is a real number, and the output of each artificial neuron is computed by some non-linear function of the sum of its inputs. The connections between artificial neurons are called ‘edges’. Edges typically have weights that adjust as learning proceeds. Each weight increases or decreases the strength of the signal at a connection. Artificial neurons may have a threshold such that the signal is only sent if the aggregate signal crosses that threshold. Typically, artificial neurons are aggregated into layers. Different layers may perform different kinds of transformations on their inputs. Signals travel from the first layer (the input layer) to the last layer (the output layer), possibly after traversing the layers multiple times.

Convolutional neural networks (CNNs) are a class of neural networks, most commonly applied to analyzing visual imagery. CNNs are regularized versions of multilayer perceptrons (e.g., fully connected networks), where each neuron in one layer is connected to all neurons in the next layer. CNNs take advantage of the hierarchical pattern in data and assemble more complex patterns using smaller and simpler patterns. CNNs break down images into small patches (e.g., 5×5-pixel patches), then move across the image by a designated stride length. CNNs allow the network to learn the filters that in traditional algorithms were hand-engineered.

Image segmentation typically refers to a process of partitioning a digital image into multiple image segments, also known as image regions or image objects (sets of pixels). The goal of segmentation is to simplify or change the representation of an image into something that is more meaningful and easier to analyze. The result of image segmentation is a set of segments that collectively cover the entire image, or a set of contours extracted from the image.

### SUMMARY

According to an aspect of the present invention, there is provided a computer-implemented method, a computer program product, and a computer system. The computer-implemented method includes accessing an image file; inputting the image file into a deep learning model, wherein the deep learning model includes multiple blocks, each block of the multiple blocks including a Hartley transform, mixings of features in the frequency domain with a set of learnable parameters to produce new features, and an inverse of the Hartley transform; and outputting another image file containing segmentation results of the accessed image file.

### BRIEF DESCRIPTION OF THE DRAWINGS

Preferred embodiments of the present invention will now be described, by way of example only, with reference to the following drawings, in which:

FIG. 1 depicts a block diagram of a computing environment, in accordance with an embodiment of the present invention;

FIG. 2A shows an example network architecture of a segmentation model, in accordance with an embodiment of the present invention.

FIG. 2B shows the block diagrams of the HNO block and the Hartley MHA block, in accordance with an embodiment of the present invention;

FIG. 3 is a table containing equations in accordance with an embodiment of the present invention;

FIG. 4 is a flowchart depicting operational steps for providing a deep learning model for image segmentation, in accordance with an embodiment of the present invention;

FIG. 5 is a flowchart depicting operational steps for mixing features in the frequency domain, in accordance with an embodiment of the present invention; and

FIG. 6 is a block diagram of an alternate computing environment, in accordance with an embodiment of the present invention.

### DETAILED DESCRIPTION

According to an aspect of the invention, there is provided a computer implemented method. The computer-implemented method includes accessing an image file; inputting the image file into a deep learning model, wherein the deep learning model includes multiple blocks, each block of the multiple blocks including the Hartley transform, mixings of features in the frequency domain with a set of learnable parameters to produce new features, and an inverse Hartley transform; and outputting another image file containing segmentation results of the accessed image file. Such an aspect of the invention has a technical advantage of improving the robustness of the deep learning model to training image resolution.

In embodiments, the computer-implemented method that includes accessing an image file; inputting the image file into a deep learning model, where the deep learning model includes multiple blocks, each block of the multiple blocks including the Hartley transform, mixings of features in the frequency domain with a set of learnable parameters to produce new features, and an inverse Hartley transform; and outputting another image file containing segmentation results of the accessed image file can specify that the mixings of features are performed at each frequency by learnable parameters to produce new features. Such an aspect of the invention has a technical advantage of improving the robustness of the deep learning model to training image resolution.

In embodiments, the computer-implemented method that includes accessing an image file; inputting the image file into a deep learning model, where the deep learning model includes multiple blocks, each block of the multiple blocks including the Hartley transform, mixings of features in the frequency domain with a set of learnable parameters to produce new features, and an inverse Hartley transform; and outputting another image file containing segmentation results of the accessed image file can specify that the mixings of features are performed at each frequency by learnable parameters to produce new features and can further specify that the new features of different frequencies are mixed by self-attention of Transformers to produce another set of new features. Such an aspect of the invention has a technical advantage of improving the segmentation performance by high-order feature combination.

In embodiments, the computer-implemented method that includes accessing an image file; inputting the image file into a deep learning model, where the deep learning model includes multiple blocks, each block of the multiple blocks including the Hartley transform, mixings of features in the frequency domain with a set of learnable parameters to produce new features, and an inverse Hartley transform; and outputting another image file containing segmentation results of the accessed image file can specify that the set of learnable parameters is shared by different frequencies. Such an aspect of the invention has a technical advantage of substantial reduction in model parameters.

In embodiments, the computer-implemented method that includes accessing an image file; inputting the image file into a deep learning model, where the deep learning model includes multiple blocks, each block of the multiple blocks including the Hartley transform, mixings of features in the frequency domain with a set of learnable parameters to produce new features, and an inverse Hartley transform; and outputting another image file containing segmentation results of the accessed image file includes using residual connections and deep supervision. Such an aspect of the invention has a technical advantage of improving convergence and accuracy of the deep learning model.

In embodiments, the computer-implemented method that includes accessing an image file; inputting the image file into a deep learning model, where the deep learning model includes multiple blocks, each block of the multiple blocks including the Hartley transform, mixings of features in the frequency domain with a set of learnable parameters to produce new features, and an inverse Hartley transform; and outputting another image file containing segmentation results of the accessed image file, where the deep learning model further includes a convolutional layer sequentially after an input layer for input downsampling. Such an aspect of the invention has a technical advantage of learning the optimal resampling approach.

In embodiments, the computer-implemented method that includes accessing an image file; inputting the image file into a deep learning model, where the deep learning model includes multiple blocks, each block of the multiple blocks including the Hartley transform, mixings of features in the frequency domain with a set of learnable parameters to produce new features, and an inverse Hartley transform; and outputting another image file containing segmentation results of the accessed image file, where the deep learning model includes a convolutional layer sequentially after an input layer for input downsampling further includes an output transposed convolutional layer for output upsampling. Such an aspect of the invention has a technical advantage of learning the optimal resampling approach.

According to an aspect of the invention, there is provided a computer program product. The computer program product comprises one or more computer readable storage media and program instructions stored on the one or more computer readable storage media, the program instructions including program instructions to accessing an image file; program instructions to input the image file into a deep learning model, wherein the deep learning model includes multiple blocks, each block of the multiple blocks including a Hartley transform, mixings of features in the frequency domain with a set of learnable parameters to produce new features, and an inverse of the Hartley transform; and program instructions to output another image file containing segmentation results of the accessed image file. Such an aspect of the invention has a technical advantage of improving the robustness of the deep learning model to training image resolution.

In embodiments, the computer program product that includes one or more computer readable storage media and program instructions stored on the one or more computer readable storage media, the program instructions including program instructions to access an image file; program instructions to input the image file into a deep learning model, where the deep learning model includes multiple blocks, each block of the multiple blocks including a Hartley transform, mixings of features in the frequency domain with a set of learnable parameters to produce new features, and an inverse of the Hartley transform; and program instructions to output another image file containing segmentation results of the accessed image file can specify the mixings of features are performed at each frequency by learnable parameters to produce new features. Such an aspect of the invention has a technical advantage of improving the robustness of the deep learning model to training image resolution.

In embodiments, the computer program product that includes one or more computer readable storage media and program instructions stored on the one or more computer readable storage media, the program instructions including program instructions to accessing an image file; program instructions to input the image file into a deep learning model, wherein the deep learning model includes multiple blocks, each block of the multiple blocks including a Hartley transform, mixings of features in the frequency domain with a set of learnable parameters to produce new features, and an inverse of the Hartley transform; and program instructions to output another image file containing segmentation results of the accessed image file can specify program instructions to mix the new features of different frequencies by self-attention of Transformers to produce another set of new features. Such an aspect of the invention has a technical advantage of improving the segmentation performance by high-order feature combination.

In embodiments, the computer program product that includes program instructions to access an image file; program instructions to input the image file into a deep learning model, wherein the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file can specify that the set of learnable parameters is shared by different frequencies. Such an aspect of the invention has a technical advantage of substantial reduction in model parameters.

In embodiments, the computer program product that includes program instructions to accessing an image file; program instructions to inputting the image file into a deep learning model, where the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file includes using residual connections and deep supervision. Such an aspect of the invention has a technical advantage of improving convergence and accuracy of the deep learning model.

In embodiments, the computer program product that includes program instructions to access an image file; program instructions to input the image file into a deep learning model, wherein the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file, where the deep learning model further includes a convolutional layer sequentially after an input layer for input downsampling. Such an aspect of the invention has a technical advantage of learning the optimal resampling approach.

In embodiments, the computer program product that includes program instructions to access an image file; program instructions to input the image file into a deep learning model, where the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file, where the deep learning model includes a convolutional layer sequentially after an input layer for input downsampling further includes an output transposed convolutional layer for output upsampling. Such an aspect of the invention has a technical advantage of learning the optimal resampling approach.

According to an aspect of the invention, there is provided a computer system. The computer system comprising one or more computer processors, one or more computer readable storage media, and program instructions stored on the one or more computer readable storage media for execution by at least one of the one or more computer processors includes program instructions to access an image file; program instructions to input the image file into a deep learning model, where the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file. Such an aspect of the invention has a technical advantage of improving the robustness of the deep learning model to training image resolution.

In embodiments, the computer system that includes program instructions to access an image file; program instructions to input the image file into a deep learning model, where the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file can specify that the mixings of features are performed at each frequency by learnable parameters to produce new features. Such an aspect of the invention has a technical advantage of improving the robustness of the deep learning model to training image resolution.

In embodiments, the computer system that includes program instructions to access an image file; program instructions to input the image file into a deep learning model, where the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file can specify that the mixings of features are performed at each frequency by learnable parameters to produce new features and can further specify that the new features of different frequencies are mixed by self-attention of Transformers to produce another set of new features. Such an aspect of the invention has a technical advantage of improving the segmentation performance by high-order feature combination.

In embodiments, the computer system that includes program instructions to access an image file; program instructions to input the image file into a deep learning model, where the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file can specify that the set of learnable parameters is shared by different frequencies. Such an aspect of the invention has a technical advantage of substantial reduction in model parameters.

In embodiments, the computer system that includes program instructions to access an image file; program instructions to input the image file into a deep learning model, where the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file includes using residual connections and deep supervision. Such an aspect of the invention has a technical advantage of improving convergence and accuracy of the deep learning model.

In embodiments, the computer system that includes program instructions to access an image file; program instructions to input the image file into a deep learning model, where the deep learning model includes multiple blocks, each block of the multiple blocks including the Hartley transform, mixings of features in the frequency domain with a set of learnable parameters to produce new features, and an inverse Hartley transform; and program instructions to output another image file containing segmentation results of the accessed image file, where the deep learning model further includes a convolutional layer sequentially after an input layer for input downsampling, and an output transposed convolutional layer for output upsampling. Such an aspect of the invention has a technical advantage of learning the optimal resampling approach.

Embodiments of the present invention recognize convolutional neural networks (CNNs) have been widely used for medical image segmentation because of their speed and accuracy. Nevertheless, given the local receptive fields of convolutional layers, long-range spatial correlations are mainly captured through consecutive convolutions and pooling. To balance between computational complexity and network capability, input size reductions by image downsampling and patch-wise training are common approaches. However, CNNs trained with downsampled images can be suboptimal when applied on the original resolution, and the receptive field of patch-wise training can be largely reduced depending on the patch size.

With the introduction of Transformers and their vision alternatives the self-attention mechanism for long-range dependencies has been adopted to medical image segmentation with promising results. These approaches form a sequence of samples by either using the pixel values of low-resolution features or by dividing an image into smaller patches, and the multi-head attention is used to learn the dependencies among samples. Although these self-attention approaches allow capturing of long-range dependencies, as the computational requirements are proportional to sequence lengths and patch sizes which are proportional to image sizes, size-reduction approaches are needed for large images.

As image size reduction is usually required for large images, embodiments of the present invention provide a model that is robust to training image resolution so that the trained model can be applied to higher-resolution images with decent accuracy. Furthermore, as self-attention of Transformers allows better expressiveness through high-order channel and sample mixing, incorporating self-attention in an efficient way can be beneficial. To gain these advantages, embodiments of the present invention provide a Hartley Multi-Head Attention (MHA) model which is a resolution-robust and parameter-efficient network architecture with frequency-domain self-attention for image segmentation. This model is based on the Fourier neural operator (FNO), which is a deep learning model that learns mappings between functions in partial differential equations (PDEs) and has the appealing properties of zero-shot super-resolution and global receptive field.

More specifically, embodiments of the present invention utilize the FNO for computationally expensive segmentation and modify it by using the Hartley transform with shared model parameters in the frequency domain. Embodiments of the present invention uses residual connections and deep supervision and can be referred to as the Hartley Neural Operator Segmentation (HNOSeg) model. Using this approach, embodiments of the present invention reduce the number of model parameters by orders of magnitude and improve accuracy.

As only low-frequency components are required for decent segmentation results, embodiments of the present invention can adapt the multi-head self-attention to be efficiently applied in the frequency domain. This allows high-order combination of features to improve the expressiveness of the model (e.g., the HartleyMHA model).

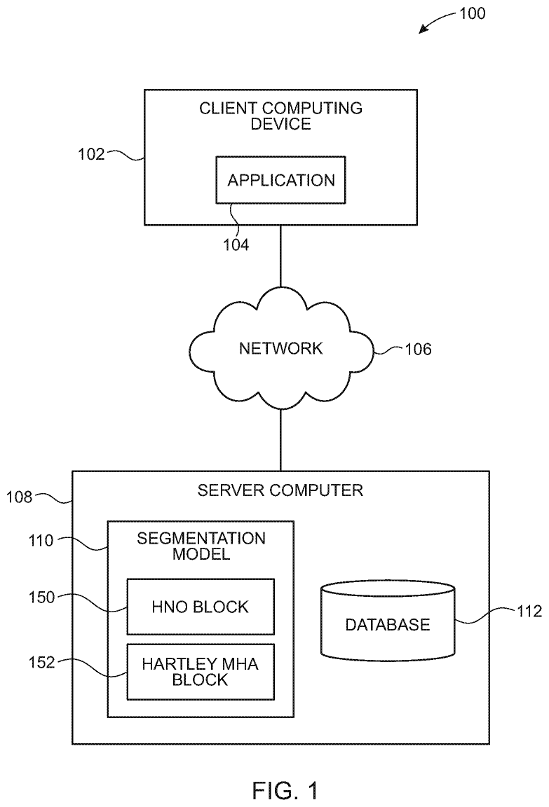

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

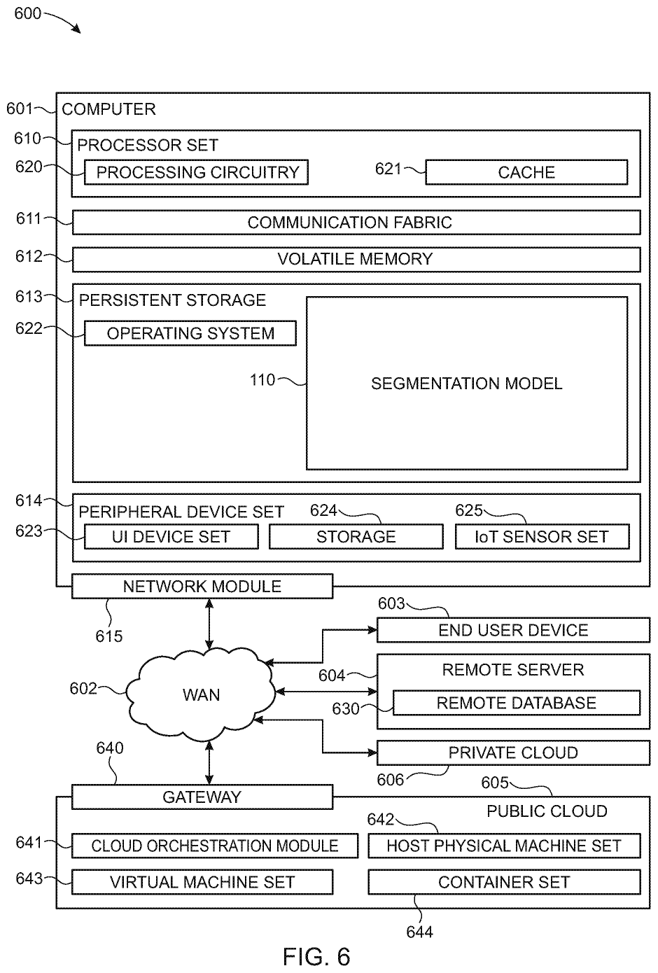

Computing environment 100 includes client computing device 102 and server computer 108, all interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computers as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 6.

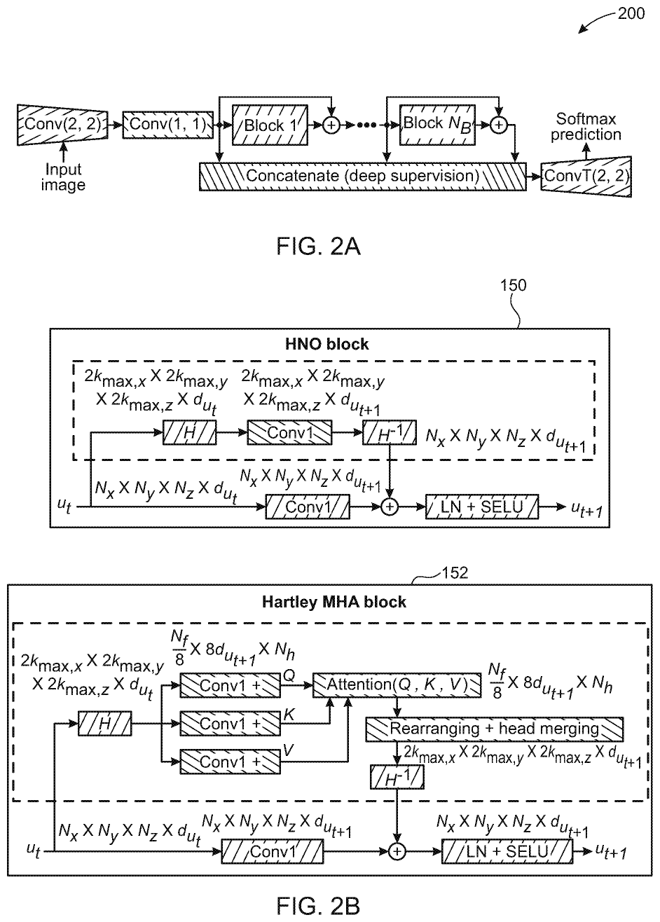

In this embodiment, client computing device 102 is a user device associated with a user and includes application 104. Application 104 communicates with server computer 108 to access segmentation model 110 (e.g., using TCP/IP) to access user information and database information. Application 104 can further communicate with segmentation model 110 which is modified from FNO by using the Hartley transform with shared parameters to reduce the model size by orders of magnitude, and further apply self-attention in the frequency domain for more expressive high-order feature combination with improved efficiency, as discussed in greater detail in FIGS. 2-6.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts segmentation model 110 and database 112. In this embodiment, segmentation model 110 resides on server computer 108. In other embodiments, segmentation model 110 can have an instance of the program (not shown) stored locally on client computing device 102. In other embodiments, segmentation model 110 can be a standalone program or system that can be integrated in one or more computing devices having a display screen.

Segmentation model 110 (as referred to as program code) includes Hartley neural operator (HNO) blocks or Hartley multi-head attention (Hartley MHA) blocks (e.g., HNO block 150 and MHA block 152 both shown and described in greater detail with respect to FIG. 2B). Different from the FNO, segmentation model 110 uses residual connections and deep supervision to improve the training stability, convergence, and accuracy. As the batch size is usually small for memory demanding large image segmentation, layer normalization (LN) is used.

Segmentation model 110 uses the SELU as the activation function, and the softmax function is used to produce the final prediction scores. Similar to the Fourier transform, the Hartley transform provides a global receptive field as all voxels are used to compute the value at each frequency, thus pooling is not required. As using the original image resolution may result in out-of-memory errors in large image segmentation, downsampling the inputs and then upsampling the predictions may be required. Instead of using traditional image resampling methods, segmentation model 110 uses a convolutional layer with the kernel size and stride of two right after the input layer and replaces the output convolutional layer by a transposed convolutional layer with the kernel size and stride of two. In this way, the model can learn the optimal resampling approach.

Segmentation model 110 learns mappings between functions in partial differential equations using the Green's function. To efficiently solve the spatial integration associated with the kernel integral operator, segmentation model 110 uses the convolution theorem, which states that the Fourier transform of a convolution of two functions is the pointwise product of their Fourier transforms. Therefore, the spatial integration becomes the inverse Fourier transform of the pointwise product between a learnable weight function and the Fourier transform of hidden variables. In FNO, as a weight matrix is required at each frequency, the models built have tens of million parameters even only low-frequency components are used.

As the FNO requires complex number operations in the frequency domain, the computational requirements such as memory and floating-point operations are higher than with real numbers. Therefore, segmentation model 110 uses the Hartley transform instead, which is an integral transform alternative to the Fourier transform. The Hartley transform converts real-valued functions in the spatial domain to real-valued functions in the frequency domain. Similar to using the Fourier transform, the models built using the Hartley transform have tens of million parameters even though only low-frequency components are used. To remedy this issue, segmentation model 110 uses the same set of learnable parameters for all frequencies instead, which simplifies the computation and largely reduces the number of parameters without affecting the accuracy.

Segmentation model 110 applies multi-head attention in Transformers in the frequency domain for high-order feature combination. As only low-frequency components are required, the sequence length (number of voxels) can be largely reduced. Nevertheless, the computation and memory requirements of computing the attention matrix can still be demanding. To remedy this, segmentation model 110 groups feature vectors with a patch size of 2×2×2 voxels in the frequency domain. This reduces the number of elements in the attention matrix by 64 times. As using softmax in self-attention results in suboptimal segmentations, segmentation model 110 uses the scaled exponential linear unit (SELU) instead.

Database 112 stores received information and can be representative of one or more databases that give permissioned access to segmentation model 110 or publicly available databases. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2A shows an example network architecture 200 of a segmentation model, in accordance with an embodiment of the present invention. In this example, each block in network architecture 200 is either implemented by the Hartley transform (HNO Block) or the Hartley multi-head attention (Hartley MHA block).

FIG. 2B shows the block diagrams of the HNO block and the Hartley MHA block, in accordance with an embodiment of the present invention.

In this example, Nₕ=4 is the number of heads. We use dᵤ_{ₜ₊₁}=dᵤ_{ₜ}=12, kₘₐₓ=(14, 14, 10), and N_{B}=32 with HNO block 150 and N_{B}=16 with Hartley MHA block 152. The red blocks are for learnable resampling.

In this example, Conv(r, s) represents convolution with kernel size r and stride s+LN+SELU. ConvT(r, s) represents transposed convolution with kernel size r and stride s+softmax. Conv1 represents convolution with kernel size 1 and stride 1. Conv1+ represents multi-head Conv1+2×2×2 feature grouping+stacking. [symbol] represents the Hartley transform and kₘₐₓ cropping. [symbol] ⁻¹ represents zero-padding and the inverse Hartley transform.

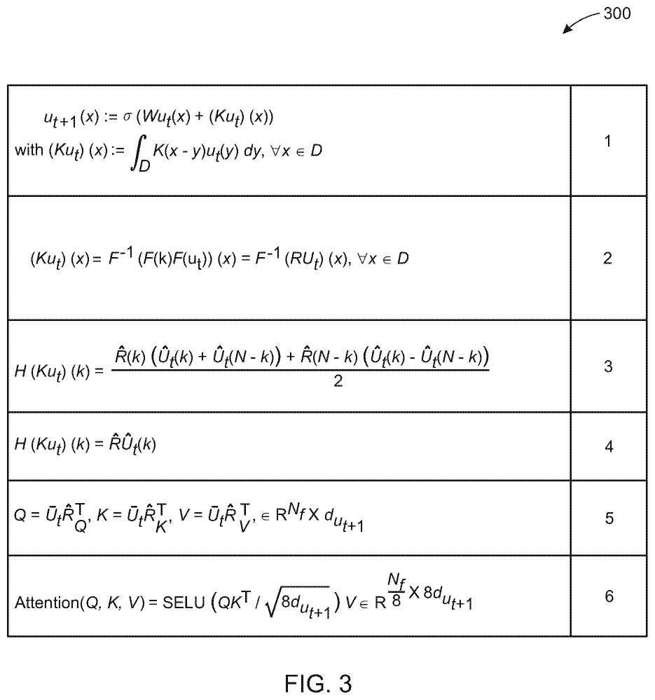

FIG. 3 is a table 300 containing equations in accordance with an embodiment of the present invention.

In this embodiment, segmentation model 110 is modified from the FNO. The FNO is a deep learning model for learning mappings between functions in PDEs without the PDEs provided. By formulating the solution in the continuous space based on the Green's function, FNO can learn a single set of model parameters for multiple resolutions. For computationally expensive 3D segmentation, such zero-shot super-resolution capability is advantageous as a model trained with lower-resolution images can be applied on higher-resolution images with decent accuracy. The neural operator is formulated as iterative updates and can be expressed as Equation 1, where uₜ(x)∈ [symbol] ^{d}^{ᵤₜ} is a function of x. W∈ [symbol] ^{d}^{ᵤ₊₁}^{×d}^{ᵤₜ} is a learnable linear transformation and σ accounts for normalization and activation. In this example, D∈ [symbol] ³ represents the 3D imaging space, and uₜ(x) are the outputs of hidden layers with dᵤ_{ₜ} channels. [symbol] is the kernel integral operator with κ∈ [symbol] ^{d}^{ᵤₜ₊₁}^{×d}^{ᵤₜ} a learnable kernel function.

As ( [symbol] uₜ) is a convolution, it can be efficiently solved by the convolution theorem which states that the Fourier transform ( [symbol] ) of a convolution of two functions is the pointwise product of their Fourier transforms as expressed by Equation 2, where R(k)=( [symbol] K)(k)∈ [symbol] ^{d}^{ᵤₜ₊₁}^{×d}^{ᵤₜ} is a learnable function in the frequency domain and Uₜ(k)=( [symbol] uₜ)(k)∈ [symbol] ^{d}^{ᵤₜ}. Therefore, each pointwise product at k is realized as a matrix multiplication. When the fast Fourier transform is used in implementation, k∈ [symbol] ³ are non-negative integer coordinates, and each k has a learnable R(k). As mainly low-frequency components are required for image segmentation, only kᵢ≤k_{max,i} corresponding to the lower frequencies in each dimension i are used to reduce model parameters and computation time.

As the FNO requires complex number operations in the frequency domain, the computational requirements such as memory and floating-point operations are higher than with real numbers. Therefore, the Hartley transform is used instead, which is an integral transform alternative to the Fourier transform. The Hartley transform ( [symbol] ) converts real-valued functions to real-valued functions, which is related to the Fourier transform as ( [symbol] f)=Real( [symbol] f)−Imag( [symbol] f). The convolution theorem of discrete Hartley transform is more complicated, and the kernel integration in Equation 1 is represented as Equation 3, with

$$\hat{R} ( k ) = ( ℋ κ ) ( k ) ∈ {ℝ}^{{d}_{{u}_{t + 1}} \times {d}_{{u}_{t}}} and {\hat{U}}_{t} ( k ) = ( ℋ {u}_{t} ) ( k ) ∈ {ℝ}^{{d}_{{u}_{t}}} \cdot N = ( {N}_{x} , {N}_{y} , {N}_{z} ) ∈ {ℕ}^{3}$$

is the size of the frequency domain. \hat{R} and Û are N-periodic in each dimension. Using the same (i.e., shared) \hat{R} for all k, embodiments of the present invention can reduce model parameters by orders of magnitutdes without losing accuracy.

Similar to using Equation 2, the models built using Equation 3 have tens of million parameters even with small kₘₐₓ (e.g., (14, 14, 10)). Therefore, instead of using a different Ŕ (k) at each k, segmentation model 110 uses the same (shared) \hat{R} for all k and Equation 3 becomes Equation 4. Equation 4 is equivalent to applying a convolution layer with the kernel size of one in the frequency domain, and this simplifies the computation and largely reduces the number of parameters without affecting the accuracy.

As real instead of complex numbers are used in Equation 4, multi-head attention can be applied in the frequency domain for high-order feature combination. As kₘₐₓ can be much smaller than the image size for image segmentation, the sequence length (number of voxels) can be largely reduced. With Equation 4, the query, key, and value matrices (Q, K, V) of self-attention can be computed with Equation 5, where

$${\overline{U}}_{t} ∈ {ℝ}^{{N}_{f} \times {d}_{{u}_{t}}} ,$$

with N_{f}=8 k_{max,x}k_{max,y}k_{max,z}, is a 2D matrix formed by stacking Ûₜ(k). Although N_{f} can be relatively small, the computation and memory requirements of computing QK^{T} can still be demanding. For example, kₘₐₓ=(14, 14, 10) corresponds to an attention matrix with around 246 M elements. To remedy this, for each Q, K, and V, embodiments of the present invention group the feature vectors with a patch size of 2×2×2 voxels in the frequency domain and their matrix sizes become

$$\frac{{N}_{f}}{8} \times 8 {d}_{{u}_{t + 1}} .$$

This reduces the number of elements in QK^{T} by 64 times.

Embodiments of the present invention can then use self-attention, computed with Equation 6. In Equation 6, SELU represents the scaled exponential linear unit. As using softmax in self-attention results in suboptimal segmentations, embodiments of the present invention utilize SELU after testing with multiple activations. Furthermore, embodiments of the present invention do not utilize position encoding because it is unnecessary. The result of Equation 6 can be rearranged back to the original shape in the frequency domain so that the inverse Hartley transform can be applied. The multi-head attention can be used with Equation 6.

To train segmentation model 110, images of different modalities are stacked along the channel axis to provide a multi-channel input. As the intensity ranges across modalities can be quite different, intensity normalization is performed on each image of each modality. Image augmentation with rotation (axial, ±30°), shifting (±20%), and scaling ([0.8, 1.2]) is used and each image has an 80% chance to be transformed. The Adamax optimizer was used with the cosine annealing learning rate scheduler, with the maximum and minimum learning rates as 10⁻² and 10⁻³, respectively. The Pearson's correlation coefficient loss is used as it is robust to learning rate for image segmentation and it consistently outperformed the Dice loss and weighted cross-entropy in our experiments. An NVIDIA Tesla P100 GPU with 16 GB memory is used with a batch size of one and 100 epochs, and Keras in TensorFlow 2.6.2 is used for implementation.

The dataset of BraTS' 19 with 335 cases of gliomas was used, each with four modalities of T1, post-contrast T1, T2, and T2-FLAIR images with 240×240×155 voxels. There is also an official validation dataset of 125 cases in the same format without given annotations. Models were trained with images downsampled by different factors (1, 2, 3, and 4) to study the robustness to image resolution. In training, we split the training dataset (335 cases) into 90% for training and 10% for validation. In testing, each model was tested on the official validation dataset (125 cases) with 240×240×155 voxels regardless of the downsampling factor. The predictions were uploaded to the CBICA Image Processing Portal for the results statistics of the “whole tumor” (WT), “tumor core” (TC), and “enhancing tumor” (ET) regions.

Embodiments of the present invention using segmentation models with HNO block 150 (HNOSeg) and Hartley MHA block 152 (HartleyMHA) were compared against three other models: (1) V-Net-DS, a V-Net with deep supervision representing the commonly used encoding-decoding architectures, (2) UTNet, a U-Net enhanced by the Transformer's attention mechanism, and (3) FNO, an original FNO without shared parameters, residual connections, and deep supervision.

At the original resolution, V-Net-DS and UTNet outperformed HNOSeg and HartleyMHA by less than 3% in the Dice coefficient on average, but HNOSeg and HartleyMHA only had less than 50 k model parameters which were less than 1% of V-Net-DS and UTNet. FNO performed worst with the most parameters (144.5 M). As the resolution decreased, the accuracies of V-Net-DS and UTNet decreased almost linearly with the downsampling factor, while HNOSeg and HartleyMHA were more robust. When the downsampling factor changed from 1 to 3, the average Dice coefficients of V-Net-DS and UTNet decreased by more than 14.8%, while those of HNOSeg and HartleyMHA only decreased by less than 2.5%. Similar trends can be observed for the 95% Hausdorff distance, except that FNO performed surprisingly well in this aspect. HartleyMHA performed better overall than HNOSeg.

For computation cost, V-Net-DS and UTNet had shorter inference times than HNOSeg and HartleyMHA, though all models used less than 0.8 seconds per image of size 240×240×155. HartleyMHA ran faster than HNOSeg and used less memory, though HartleyMHA had more parameters.

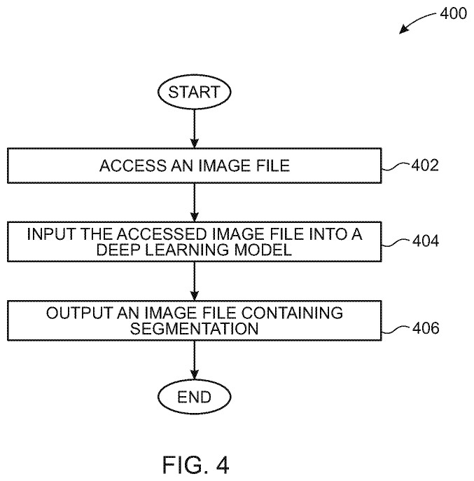

FIG. 4 is a flowchart 400 depicting operational steps for providing a deep learning model for image segmentation, in accordance with an embodiment of the present invention.

In step 402, segmentation model 110 access an image file. In this embodiment, segmentation model 110 accesses an image file from one or more components of computing environment 100. For example, segmentation model 110 can access an image file from database 112. In this embodiment, the image file can contain large amounts of data (i.e., big data having comp). In certain other embodiments, segmentation model 110 can receive an image file containing large amounts of data in relation to a processing environment such that the operations of the processing environment would perform at speeds less than normal for that processing environment based on the processing environments system (e.g., CPU, memory, hard drive) or that processing the received image file would be computationally wasteful.

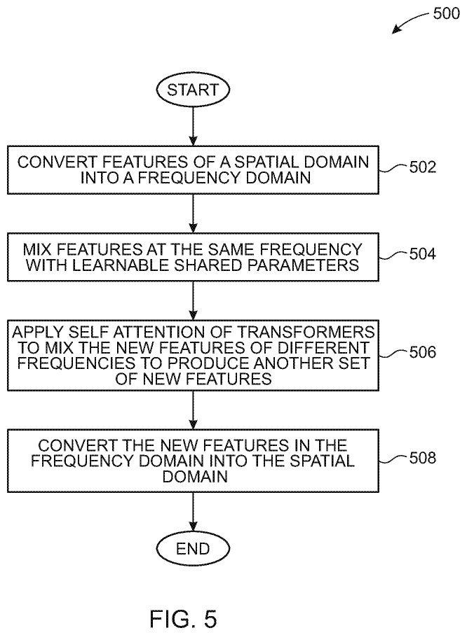

In step 404, segmentation model 110 inputs the accessed image file into a deep learning model. In this embodiment, segmentation model 110 inputs the accessed image file into a deep learning model. In this embodiment, the deep learning model includes multiple blocks, each block of the multiple blocks including the Hartley transform mixings of features in the frequency domain with learnable parameters to produce new features and the inverse Hartley transform, as discussed in greater detail with respect to FIG. 5.

In step 406, segmentation model 110 outputs an image file containing the segmentation result. In this embodiment, the outputted image file is a new file that contains the segmentation result of the accessed image file in step 402.

FIG. 5 is a flowchart 500 depicting operational steps for self-attention in the frequency domain, in accordance with an embodiment of the present invention.

In step 502, segmentation model 110 converts features of a spatial domain into a frequency domain. In this embodiment, segmentation model 110 converts features of a spatial domain into a frequency domain using the Hartley transform. “Features”, also referred to as deep features represent abstract and complex representations that a deep learning model, particularly a neural network, automatically derives from raw data during the training process.

In step 504, segmentation model 110 mixes features at the same frequency using learnable shared parameters to produce new features.

In step 506, segmentation model 110 applies self-attention to mix the new features of different frequencies to produce another set of new features. In this way, high-order feature mixing is achieved.

In step 508, segmentation model 110 converts the new features in the frequency domain back into the spatial domain. In this embodiment, segmentation model 110 converts the new features in the frequency domain back into the spatial domain using an inverse Hartley transform.

Based on the idea of FNO which has the properties of zeroshot super-resolution and global receptive field, embodiments of the present invention provide mechanisms for the HNOSeg and HartleyMHA models for resolution-robust and parameter-efficient 3D image segmentation. Embodiments of the present invention improves FNO by the Hartley transform, residual connections, deep supervision, and shared parameters in the frequency domain. Embodiments of the present invention apply this concept for efficient multi-head attention in the frequency domain as HartleyMHA. Experimental results show that HNOSeg and HartleyMHA had similar accuracies as other tested segmentation models when trained with the original image resolution but had better performance when trained with images of much lower resolutions. HartleyMHA performed slightly better than HNOSeg and ran faster with less memory. With these advantages, HartleyMHA can be a promising alternative for 3D image segmentation.

FIG. 6 depicts an alternate block diagram of components of computing systems within computing environment 100 of FIG. 1, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as segmentation model 110 (also referred to as block 110) which continuously reconciles desired states and provides polymorphous intent based management as discussed previously with respect to FIGS. 2-5.

In addition to block 110, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 110, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 110 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 110 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

What is claimed is:

1. A computer-implemented method comprising:
accessing an image file;
inputting the image file into a deep learning model, wherein the deep learning model includes multiple blocks, each block of the multiple blocks including a Hartley transform, mixings of features in the frequency domain with a set of learnable parameters to produce new features, and an inverse of the Hartley transform; and
outputting another image file containing segmentation results of the accessed image file.

2. The method of claim 1, wherein the mixings of features are performed at each frequency by learnable parameters to produce new features.

3. The method of claim 2, further comprising:
mixing the new features of different frequencies by self-attention of Transformers to produce another set of new features.

4. The method of claim 1, wherein the set of learnable parameters is shared by different frequencies.

5. The method of claim 1, further comprising:
improving convergence and accuracy by using residual connections and deep supervision.

6. The method of claim 1, wherein the deep learning model includes a convolutional layer sequentially after an input layer for input downsampling.

7. The method of claim 6, further comprising an output transposed convolutional layer for output upsampling.

8. A computer program product comprising:
one or more computer readable storage media and program instructions stored on the one or more computer readable storage media, the program instructions comprising:
program instructions to accessing an image file;
program instructions to input the image file into a deep learning model, wherein the deep learning model includes multiple blocks, each block of the multiple blocks including a Hartley transform, mixings of features in the frequency domain with a set of learnable parameters to produce new features, and an inverse of the Hartley transform; and
program instructions to output another image file containing segmentation results of the accessed image file.

9. The computer program product of claim 8, wherein the mixings of features are performed at each frequency by learnable parameters to produce new features.

10. The computer program product of claim 9, wherein the program instructions stored on the one or more computer readable storage media further comprise:
program instructions to mix the new features of different frequencies by self-attention of Transformers to produce another set of new features.

11. The computer program product of claim 8, wherein the set of learnable parameters is shared by different frequencies.

12. The computer program product of claim 8, wherein the program instructions stored on the one or more computer readable storage media further comprise:
program instructions to improve convergence and accuracy by using residual connections and deep supervision.

13. The computer program product of claim 8, wherein the deep learning model includes a convolutional layer sequentially after an input layer for input downsampling.

14. The computer program product of claim 13, further comprising an output transposed convolutional layer for output upsampling.

15. A computer system comprising:
one or more computer processors;
one or more computer readable storage media; and
program instructions stored on the one or more computer readable storage media for execution by at least one of the one or more computer processors, the program instructions comprising:
program instructions to accessing an image file;
program instructions to input the image file into a deep learning model, wherein the deep learning model includes multiple blocks, each block of the multiple blocks including a Hartley transform, mixings of features in the frequency domain with a set of learnable parameters to produce new features, and an inverse of the Hartley transform; and
program instructions to output another image file containing segmentation results of the accessed image file.

16. The computer system of claim 15, wherein the mixings of features are performed at each frequency by learnable parameters to produce new features.

17. The computer system of claim 16, wherein the program instructions stored on the one or more computer readable storage media further comprise:
program instructions to mix the new features of different frequencies by self-attention of Transformers to produce another set of new features.

18. The computer system of claim 15, wherein the set of learnable parameters is shared by different frequencies.

19. The computer system of claim 15, wherein the program instructions stored on the one or more computer readable storage media further comprise:
program instructions to improve convergence and accuracy by using residual connections and deep supervision.

20. The computer system of claim 15, wherein the deep learning model includes a convolutional layer sequentially after an input layer for input downsampling, and an output transposed convolutional layer for output upsampling.
